(19) United States
(12) Patent Application Publication
(10) Pub. No.: US 2010/0158189 A1
(43) Pub. Date: Jun. 24, 2010

(54) MOSSBAUER SPECTROMETER

(75) Inventor: Yutaka Yoshida, Fukuroi-shi (JP)

Correspondence Address: SUGHRUE MION, PLLC, 2100 PENNSYLVANIA AVENUE, N.W., SUITE 800, WASHINGTON, DC, 20037, US

(73) Assignee: HAMAMATSU FOUNDATION FOR SCIENCE AND TECHNOLOGY PROMOTION, Hamamatsu-shi ,Shizuoka (JP)

(21) Appl. No.: 12/599,913

(22) PCT Filed: May 14, 2008
(86) PCT No.: PCT/JP2008/058870

§ 371 Date: Jan. 28, 2010

(30) Foreign Application Priority Data
May 15, 2007 (JP) 2007-129585

(51) Int. Cl. G01N 23/22; G21K 1/00

(52) U.S. Cl. 378/3

(57) ABSTRACT

A Mossbauer spectrometer 1A uses a configuration including: a stage 10 for holding a sample S; a γ-ray irradiating unit 15 for supplying measurement γ rays; γ-ray converging unit 18 for irradiating the sample S with the measurement γ rays in a converging manner; an electron detector 20, having an opening through which the measurement γ rays are passed and being configured so that a surface on a side of the stage 10 is used as an electron incident surface, for detecting internal conversion electrons from the target substance in the sample S in which the measurement γ rays are absorbed in resonance; an irradiation position moving unit for two-dimensionally moving an irradiation position of the measurement γ rays with respect to the sample S within an XY plane; and an energy selecting voltage applying unit for selecting energy of the electrons detected by the electron detector 20 by applying voltage to the electron incident surface of the electron detector 20 so that a potential of the electron incident surface is a negative potential with respect to the sample S. Thereby, a Mossbauer spectrometer capable of acquiring information of a microstructure about a target substance in a sample is realized.

### TECHNICAL FIELD

The present invention relates to a Mossbauer spectrometer for irradiating a sample with γ rays having a predetermined energy so as to perform Mossbauer spectrometry on a target substance included in the sample.

### BACKGROUND ART

A Mossbauer spectrometric method is a measurement method in which, for a bulk material sample, a hyperfine interaction between an atomic nucleus of a target substance subject to spectrometry and its surrounding electrons and the like is utilized so as to enable the acquisition of atomic-scale information about the sample such as a chemical state of the atom or a state of the neighboring crystal, magnetic structure, and lattice defects.

In Mossbauer spectrometry, the sample is irradiated with γ rays having a predetermined energy that are supplied from a γ-ray source. At this time, in the nucleus of the target substance in the sample, recoilless resonance absorption of γ ray caused by the Mossbauer effect takes place, and by observing this resonance absorption, information about a state of the target substance, such as changes in the energy level of the target substance in the sample, can be acquired. For example, if the target substance is ⁵⁷Fe, a ⁵⁷Co source is used as a γ-ray source, and γ rays having an energy of 14.4 keV that are emitted from the radiation source are used for spectrometry (see, for example, Patent Documents 1 to 3, Non-Patent Documents 1 and 2).
Patent Document 1: Japanese Patent Application Laid-Open No. H8-201318
Patent Document 2: Japanese Patent Application Laid-Open No. H9-49809
Patent Document 3: Japanese Patent Application Laid-Open No. S64-43747
Non-Patent Document 1: Y. Yoshida et al., “Mossbauer-Spectroscopic Iron Microscope,” 6th Seeheim Workshop on Mossbauer Spectroscopy, Jun. 7-11, 2006, Seeheim, Germany
Non-Patent Document 2: Yutaka Yoshida, Fifth RSP Promotion Test Research Result Symposium, Final Report, “Development of Microscopic Mossbauer Spectrometer for Mapping Measurements of Iron Impurities in Silicon,” Feb. 18, 2005, Bouquet Tokai Shizuoka

### DISCLOSURE OF THE INVENTION

### Problem To Be Solved By the Invention

The above-described Mossbauer spectrometry is used to analyze and evaluate the iron atoms in a sample in various fields, such as material science, chemistry, material technology, physics, mineralogy, medicine, and environmentology. Furthermore, advancements are being made in the accumulation of the spectroscopic data of the Mossbauer spectrometry and its conversion into a database, and the spectroscopic data are used in various spectrometric measurements. However, a problem with such Mossbauer spectrometric measurements is that the information about the microstructure and the micro-organization of the target substance in the sample cannot be acquired directly.

The present invention has been achieved to resolve the above-described problem, and an object thereof is to provide a Mossbauer spectrometer capable of acquiring information about the microstructure of a target substance in a sample.

### Means For Solving the Problem

For measuring the above-described microstructure of the target substance in the sample by the Mossbauer spectrometry, the present inventor used a Multi Capillary Lens developed for convergence of X-rays (MCX: Multi Capillary X-ray Lens, see Japanese Patent Publication No. H7-11600, Japanese Patent Publication No. H7-40080, and Document “H. Soejima and T. Narusawa, Advances in X-ray Analysis, Vol. 44 pp. 320-324 (2001)”) for the purpose of converging the γ rays, and at the same time, made advancements in the development of a Mossbauer spectrometer configured to perform spectrometry by detecting internal conversion electrons emitted from the target substance in the sample (see Non-Patent Documents 1 and 2).

According to the configuration in which the above-described MCX is used, when the γ rays for Mossbauer spectrometry are converged into a sufficiently small spot size and the sample is irradiated with the resultant γ rays, spectrometry can be performed on the target substance in the sample with high position resolution. Furthermore, in such a configuration, by moving the irradiation position of the γ rays with respect to the sample within a plane perpendicular to the irradiation axis, two-dimensional measurement of the target substance in the sample is also possible.

However, in the case of such a spectrometer, it is not possible to obtain information about a direction of depth of the sample. As a result of diligent examinations related to this problem, the present inventor found that the energy of the internal conversion electron emitted from the sample largely depended on the depth from the sample surface at a position where the internal conversion electron is generated after the occurrence of resonance absorption of γ ray by the target substance in the sample, and reached the present invention.

That is, the Mossbauer spectrometer according to the present invention includes: (1) a sample stage for holding a sample containing a target substance under Mossbauer spectrometry; (2) γ-ray irradiating means, having a γ-ray source for supplying measurement γ rays, that is, γ rays having a predetermined energy and used for Mossbauer spectrometry, for irradiating the sample with the measurement γ rays along a predetermined irradiation axis; (3) converging means, placed between the γ-ray irradiating means and the sample stage, for irradiating the sample with the measurement γ rays in a converging manner; (4) electron detecting means, placed between the converging means and the sample stage, having an opening through which the measurement γ rays from the converging means are passed, and configured so that a surface on a side of the sample stage is used as an electron incident surface, for detecting internal conversion electrons emitted from the target substance in the sample in which the measurement γ rays are absorbed in resonance by the Mossbauer effect; (5) irradiation position moving means for two-dimensionally moving an irradiation position of the measurement γ rays with respect to the sample within a plane perpendicular to the irradiation axis; and (6) energy selecting voltage applying means for selecting energy of the electrons detected by the electron detecting means, out of the electrons from the sample, by applying an energy selecting voltage to the electron incident surface of the electron detecting means so that a potential of the electron incident surface is a negative potential with respect to the sample on the sample stage.

In the above-described Mossbauer spectrometer, between the γ-ray irradiating means for supplying γ rays for spectrometry and the sample stage for holding a sample containing a target substance, the converging means is arranged so as to irradiate the sample with the measurement γ rays from the γ-ray source in a converging manner. Thereby, information about the target substance in the sample can be acquired with a high position resolution. Moreover, there is arranged the irradiation position moving means for two-dimensionally (in the X direction and Y direction) moving an irradiation position of the converged γ rays to the sample within a plane perpendicular to the irradiation axis. Thus, when the irradiation position of the measurement γ rays is two-dimensionally scanned on the sample, it becomes possible to perform two-dimensional measurement on the target substance in the sample, as described above.

Further, it is configured so that the electron detecting means having an opening through which the measurement γ rays are passed is placed between the converging means and the sample stage, and by the electron detecting means, the electrons emitted from the sample are detected. By using the electron detecting means having such a configuration, it becomes possible to preferably make a converged irradiation to the sample with the γ rays supplied from the γ-ray irradiating means compatible with a detection of the internal conversion electrons from a target substance in which resonance absorption of γ rays occurs in the sample.

Moreover, in such a configuration, an energy selecting voltage is applied to the electron incident surface of the electron detecting means so that a potential of the electron incident surface is a negative potential with respect to the sample on the sample stage. Herein, when the potential of the electron incident surface is 0 with respect to the sample, the electrons emitted from the sample are directly incident into the electron detecting means. On the other hand, when the potential of the electron incident surface is negative with respect to the sample, the electrons emitted from the sample are thereby decelerated, and only the electrons emitted with energy of a certain level or more reach the electron detecting means for detection. Moreover, the energy of the internal conversion electron emitted from the sample greatly depends on the depth from the surface of the sample (position in a Z direction) at a position at which the internal conversion electron is generated as a result of the occurrence of the resonance absorption of γ ray by the target substance in the sample, as described above.

Therefore, when the voltage is thus applied between the electron incident surface of the electron detecting means and the sample and the energy of the electrons detected by the electron detecting means is selected, it becomes possible to obtain not only the information about the X direction and the Y direction obtained resulting from the movement of the irradiation position, but also the information of the target substance in the sample about the Z direction that is the direction of depth of the sample. As described above, according to the Mossbauer spectrometer having the above-described configuration, it becomes possible to acquire information of a three-dimensional microstructure about the target substance in the sample. Such three-dimensional measurement of a sample by Mossbauer spectrometry has become possible by the present invention for the first time.

### Effects of the Invention

The Mossbauer spectrometer according to the present invention is configured so that a sample is irradiated with measurement γ rays from a γ-ray source in a converging manner, there is arranged irradiation position moving means for two-dimensionally moving a converged irradiation position of the γ rays with respect to the sample within a plane perpendicular to the irradiation axis, and by electron detecting means, having an opening through which the measurement γ rays are passed, placed between the converging means and the sample stage, the electrons emitted from the sample are detected, and at the same time, configured so that an energy selecting voltage is applied to the electron incident surface of the electron detecting means so that a potential of the electron incident surface is a negative potential with respect to the sample on the sample stage, whereby the information about the three-dimensional microstructure of the target substance in the sample can be acquired.

### BRIEF DESCRIPTION OF THE DRAWINGS

FIG. 1 is a diagram schematically showing a basic configuration of a Mossbauer spectrometer.

FIG. 2 is a block diagram showing the configuration of one embodiment of the Mossbauer spectrometer.

FIG. 3 is a cross-sectional view showing one example of a specific configuration of the Mossbauer spectrometer.

FIG. 4 is a side cross-sectional view schematically showing the configuration of an MCP detector.

FIG. 5 is a cross-sectional view showing one example of a specific configuration of the MCP detector.

FIG. 6 is a schematic diagram showing one example of a control method of an irradiation position of measurement γ rays with respect to a sample.

FIG. 7 shows graphs each showing an energy distribution of electrons detected by the MCP detector.

FIG. 8 shows diagrams showing one example of a microscopic image of a sample.

FIG. 9 shows diagrams showing another example of the microscopic image of a sample.

FIG. 10 is a diagram schematically showing the configuration of a sample for depth calibration.

FIG. 11 shows diagrams showing one example of a microscopic image of the sample for depth calibration.

FIG. 12 is a graph showing one example of a Mossbauer spectrum of a sample.

FIG. 13 shows diagrams showing another example of the microscopic image of a sample.

### DESCRIPTION OF THE SYMBOLS

1A, 1B—Mossbauer spectrometer, 10—XY stage (sample stage), 11—vacuum chamber, 12—linear feedthrough, 15—γ-ray irradiating unit, 16—γ-ray source (⁵⁷Co source), 17—radiation source driving device, 18—γ-ray converging unit, 19—MCX (multi capillary lens), 20—MCP detector (electron detector), 21—MCP (micro channel plate) unit, 21a—opening, 21b—electron incident surface, 21c—electron exit surface, 22—incidence-side electrode (energy selecting electrode), 23—exit-side electrode, 22a, 23a—opening, 24—detection electrode, 24a—opening, 31—resistance, 32—capacitor, 33—amplifier circuit, 36, 37—resistance, 38—intermediate point,

40—voltage supplying unit, 41—electron multiplying power supply, 42—energy selecting power supply, 50—measurement control device, 51—measurement processing unit, 52—radiation source drive control unit, 53—stage control unit, 54—voltage application control unit, 56—display device, 57—input device.

### BEST MODES FOR CARRYING OUT THE INVENTION

Hereinafter, a preferred embodiment of the Mossbauer spectrometer according to the present invention will be described in detail, along with the drawings. In the description of the drawings, elements that are the same are provided with the same symbols and overlapping description shall be omitted. Also, the dimensional ratios in the drawings do not necessarily match those of the description.

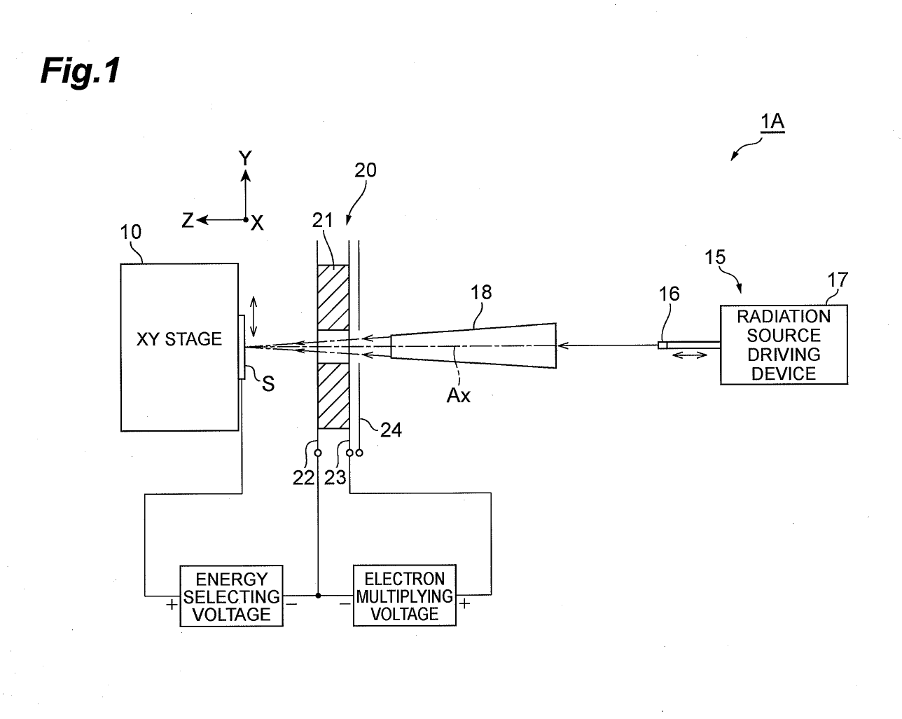

First, a basic configuration of the Mossbauer spectrometer according to the present invention is described. FIG. 1 is a diagram schematically showing the basic configuration of a Mossbauer spectrometer according to the present invention. Herein, in the following description, as shown in FIG. 1, two axes in a plane perpendicular to an irradiation axis Ax of measurement γ rays with respect to the sample S are an X axis and a Y axis, and an axis perpendicular to the X axis and Y axis and along the irradiation axis Ax is a Z axis. Both the X axis and the Y axis are axes along an incident surface of the γ rays in the sample S, respectively. Furthermore, the Z axis is an axis in a direction of depth in the sample S.

The Mossbauer spectrometer 1A shown in FIG. 1 is configured to include an XY stage 10, a γ-ray irradiating unit 15, a γ-ray converging unit 18, and an MCP detector 20 that is an electron detector. Each of these components is placed along the irradiation axis Ax of the measurement γ rays in the spectrometer 1A, in the order of the γ-ray irradiating unit 15, the γ-ray converging unit 18, the MCP detector 20, and the XY stage 10.

In the spectrometer 1A, the sample S containing a target substance under Mossbauer spectrometry is held at a predetermined position on the sample stage 10. At this time, the position on the irradiation axis Ax in the sample S is an irradiation position of the measurement γ rays for the sample S.

Furthermore, in the present configuration example, the sample stage 10 is configured as the XY stage that is a movable stage that can be two-dimensionally driven within an XY plane perpendicular to the irradiation axis Ax. Thus, by two-dimensionally driving the XY stage 10, the sample S held on the stage 10 is two-dimensionally moved in an X direction and a Y direction. Thereby, the XY stage 10 is configured such that it functions as irradiation position moving means by which the irradiation position of the measurement γ rays with respect to the sample S is two-dimensionally moved in the X direction and Y direction.

The γ-ray irradiating unit 15 is arranged as a γ-ray supplying source for measurement for the sample S on the XY stage 10. The γ-ray irradiating unit 15 is γ-ray irradiating means, having a γ-ray source 16 for supplying γ rays having a predetermined energy and used for Mossbauer spectrometry (hereinafter referred to as measurement γ rays), for irradiating the sample S with the measurement γ rays along the irradiation axis Ax. In the configuration example shown in FIG. 1, this γ-ray irradiating unit 15 is configured by the γ-ray source 16 and a radiation source driving device 17 for driving the γ-ray source 16 in the direction of the irradiation axis Ax. The radiation source driving device 17 is used for performing Mossbauer spectrometry with the Doppler velocity for the sample S (see, for example, Patent Documents 1 and 2).

Between the γ-ray irradiating unit 15 and the XY stage 10 by which the sample S is held, the γ-ray converging unit 18 is placed along the irradiation axis Ax. The γ-ray converging unit 18 is converging means for irradiating the sample S with the measurement γ rays, which are supplied from the γ-ray irradiating unit 15, in a converging manner. As the γ-ray converging unit 18, it is preferable to use a multi capillary lens (MCX) that is formed by bundling together a plurality of hollow tubes so that the measurement γ rays are converged into the sample S.

As can be understood from the name, the above-described MCX (Multi Capillary X-ray Lens) is developed for the purpose of converging X rays, but the γ rays used for Mossbauer spectrometry are generally of low energy (for example, as described later, when ⁵⁷Fe is assumed as the target substance, the energy of the measurement γ ray is 14.4 keV). Therefore, by using the MCX or the like, the measurement γ rays from the γ-ray irradiating unit 15 can be converged onto the sample S.

Furthermore, between the γ-ray converging unit 18 and the XY stage 10, the electron detector 20 is placed about the irradiation axis Ax. The electron detector 20 is electron detecting means configured to have an opening through which the measurement γ rays from the γ-ray converging unit 18 are passed to the sample S, and configured such that a surface on the side of the sample stage 10 is as an electron incident surface. The electron detector 20 is configured, when the sample S is irradiated with the measurement γ rays from the γ-ray irradiating unit 15, to perform spectrometry on the sample S by detecting internal conversion electrons emitted from the target substance in the sample S in which the γ rays are absorbed in resonance by the Mossbauer effect.

Specifically, in the present configuration example, as the electron detector 20, an MCP detector including an MCP unit 21 having an electron multiplying function and being formed by a micro channel plate (MCP) of a single stage or a plurality of stages, an incidence-side electrode 22 and an exit-side electrode 23, and a detection electrode 24 is used. A specific configuration, etc., of the MCP detector 20 are described later.

For the MCP detector 20 having such a configuration, an electron multiplying voltage is applied between the incidence-side electrode 22 and exit-side electrode 23 such that the incidence-side electrode 22 is − (negative) and the exit-side electrode 23 is + (positive). Furthermore, between the sample S and the incidence-side electrode 22, an energy selecting voltage is applied such that the sample S is + (positive) and the incidence-side electrode 22 is − (negative).

In such a configuration, when the sample S on the XY stage 10 is irradiated with the measurement γ rays, which are supplied from the γ-ray irradiating unit 15, having a predetermined energy via the opening of the MCP detector 20 in a manner to be converged by the γ-ray converging unit 18, recoilless resonance absorption of the γ rays takes place in the target substance in the sample S by the Mossbauer effect. Thus, internal conversion electrons are emitted from the target substance in the sample S in which the measurement γ rays are absorbed in resonance, and these internal conversion electrons are detected by the MCP detector 20.

Furthermore, at this time, as described above, the energy selecting voltage is applied to the electron incident surface of the MCP detector 20 such that its potential becomes a negative potential with respect to the sample S on the XY stage 10. The electrons, emitted from the sample S, moving towards the MCP detector 20 are decelerated by the voltage in the reverse direction, and only the electrons emitted with energy of a certain level or more are selected and detected upon reaching the MCP detector 20.

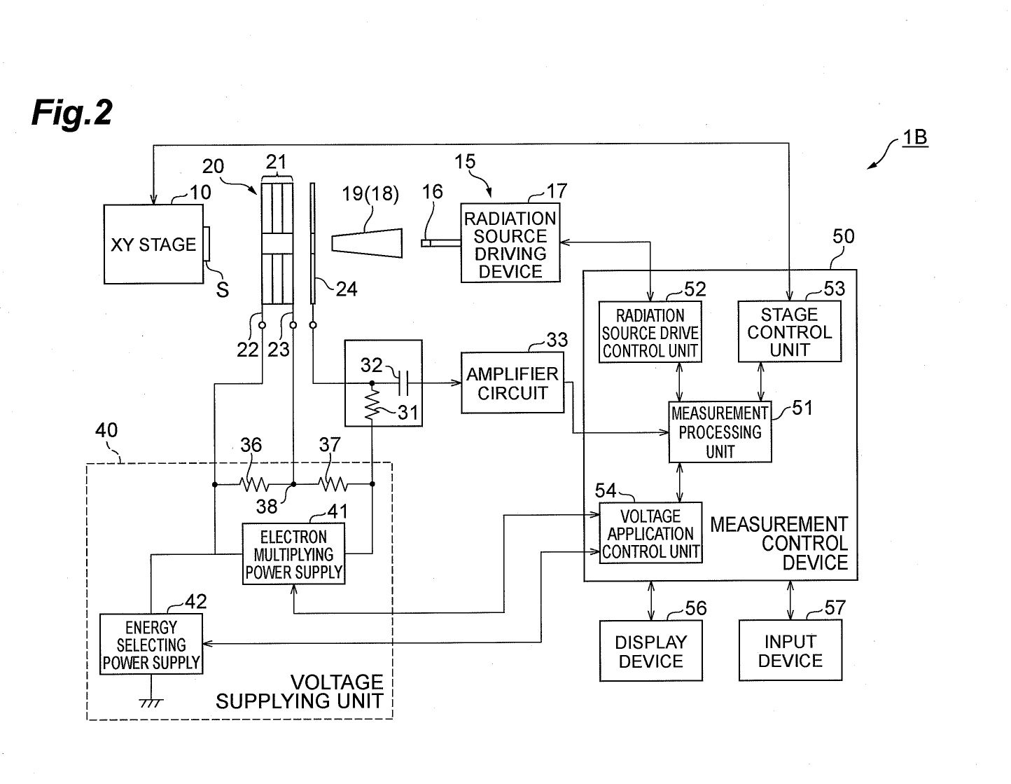

The configuration of the Mossbauer spectrometer 1A shown in FIG. 1 is described more specifically. FIG. 2 is a block diagram showing the configuration of one embodiment of a Mossbauer spectrometer. It is noted that hereinafter, the configuration, etc., of the spectrometer are described by primarily using an example in which the γ-ray source 16 for supplying the measurement γ rays is a ⁵⁷Co source, the measurement γ rays are γ rays having an energy of 14.4 keV, and at the same time, the target substance for Mossbauer spectrometry in the sample S is ⁵⁷Fe. As the ⁵⁷Co source 16 for supplying the measurement γ rays, for example, a ⁵⁷Co sealed source of 50-100 mCi may be used.

The Mossbauer spectrometer 1B according to the present embodiment is configured to include, similar to the spectrometer 1A shown in FIG. 1, the XY stage 10, the γ-ray irradiating unit 15, the γ-ray converging unit 18, and the MCP detector 20. Furthermore, in the present embodiment, as the γ-ray converging unit 18, the above-described MCX 19 is used.

As described above, the MCX 19, which is formed by bundling together a plurality of hollow tubes in a predetermined shape, converges the measurement γ rays onto a predetermined converging position while totally reflecting the γ rays on the inner walls of the hollow tubes. In the present embodiment, the MCX designed in a way that is optimum for converging γ rays having an energy of 14.4 keV is used for converging the measurement γ rays. Furthermore, between the ⁵⁷Co source 16 of the γ-ray irradiating unit 15; and the MCX 19, collimating means such as a lead collimator may also be arranged, if necessary.

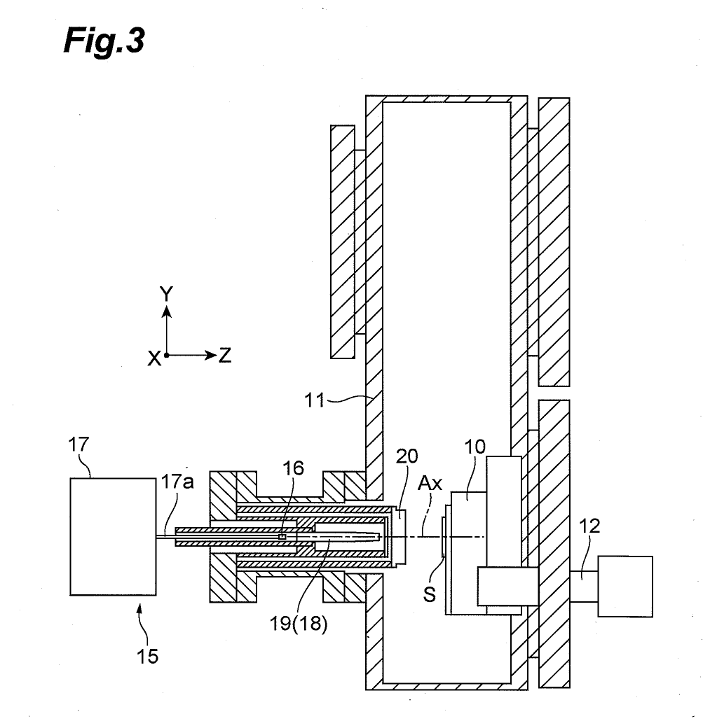

FIG. 3 is a cross-sectional view showing one example of a specific configuration of the Mossbauer spectrometer 1B. In the present configuration example, the γ-ray irradiating unit 15 is configured to include the ⁵⁷Co source 16 that is the γ-ray source, and the radiation source driving device 17 for driving the ⁵⁷Co source 16 in the Z direction that is the direction of the irradiation axis Ax. The radiation source driving device 17 includes a drive axis member 17a extended in the direction of the irradiation axis Ax, and the γ-ray source 16 is attached to the end of the drive axis member 17a.

The measurement γ rays, which are supplied from the γ-ray source 16, having an energy of 14.4 keV are introduced inside a vacuum chamber 11 via a predetermined window film, while being converged by the MCX 19. Furthermore, inside the vacuum chamber 11, the MCP detector 20 and the XY stage 10 for holding the sample S are accommodated. The measurement γ rays from the MCX 19 pass through the opening of the MCP detector 20 and are irradiated at a predetermined irradiation position on the sample S.

The distance from a γ-ray exit port of the MCX 19 to the surface of the sample S (the surface into which the measurement γ rays are incident) depends on the convergence design for the γ rays by the MCX 19, but is set to 58 mm, for example. Also, the diameter of the convergence spot of the measurement γ rays on the surface of the sample S is approximately φ150 μm, for example. Furthermore, the MCX 19 is preferably configured such that its optical axis is fine-adjustable. To realize such a configuration, for example, the central exit side of the optical axis of the MCX 19 may be optionally fine-adjustable in the range of ±2 mm.

As the XY stage 10, for example, an XY gonio stage manufactured by SIGMA KOKI Co., Ltd., can be used. The minimum movement step of the XY goniometer is approximately 10 nm, for example, while the spatial resolution of the two-dimensional images obtained by this spectrometer 1B is 20 to 50 μm, for example. Also, a linear feedthrough 12 is arranged for the XY stage 10, and this linear feedthrough 12 can be used to finely adjust the position of the sample S and the irradiation position of the measurement γ rays on the sample S in the Z direction. Thus, by adjusting the position of the sample S in the Z direction, the diameter of the convergence spot of the measurement γ rays on the sample S can be adjusted.

Furthermore, the internal conversion electrons emitted from the target substance in the sample S in which the measurement γ rays with which the sample S is irradiated are absorbed in resonance by the Mossbauer effect are detected by the MCP detector 20. Specifically, the measurement γ ray having an energy of 14.4 keV, which undergoes the recoilless resonance absorption by ⁵⁷Fe included in the sample S, is thereafter emitted as the internal conversion electron with approximately 90% probability. The emitted internal conversion electrons are emitted in vacuum from the surface while constantly losing their energy inside the sample S, and some of these electrons are detected by the MCP detector 20.

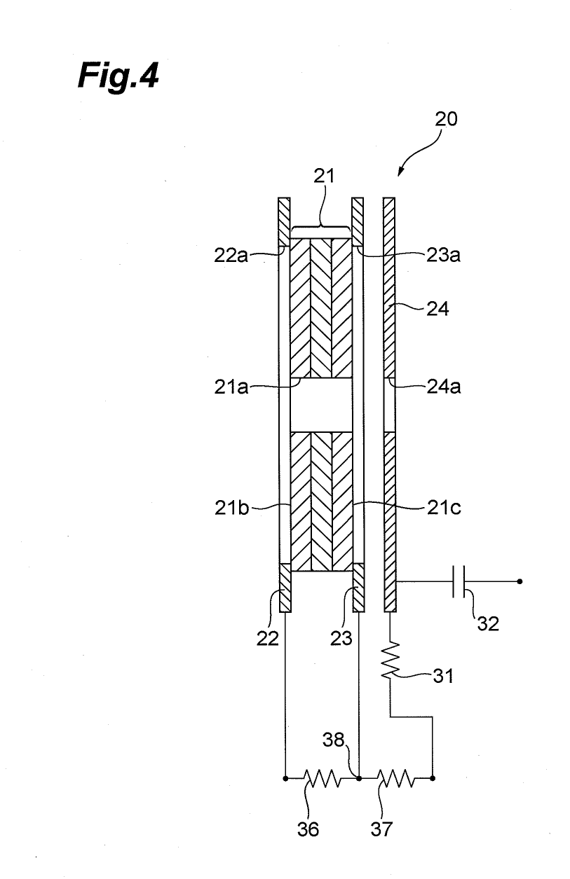

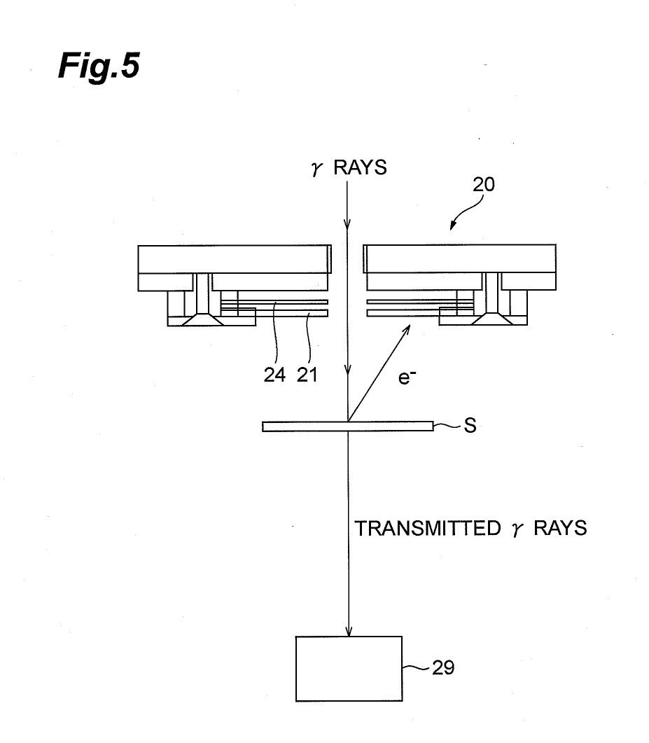

FIG. 4 is a side cross-sectional view schematically showing the configuration of the MCP detector 20. FIG. 5 is a cross-sectional view showing one example of a specific configuration of the MCP detector 20. The MCP detector 20 of the present embodiment is configured to include the MCP unit 21 and the electrodes 22, 23, and 24.

The MCP unit 21 used for multiplication of the electrons incident into the detector 20 from the sample S is configured by a circular plate shape micro channel plate (MCP) having three stages, in the example shown in FIG. 4, and one surface of the MCP unit (the surface on the side of the XY stage 10) is an electron incident surface 21b into which the electrons from the sample S are incident, and the other surface (the surface on the side of the MCX 19) is an electron exit surface 21c from which the multiplied electrons exit. Furthermore, at an approximate center of the MCP unit 21, a circular opening 21a through which the measurement γ rays from the MCX 19 are passed to the sample S is provided.

For the MCP unit 21, the incidence-side electrode 22 is arranged on the side of the electron incident surface 21b. The incidence-side electrode 22 is formed in a circular plate shape and has an opening 22a through which the measurement γ rays and the electrons multiplied and detected by the detector 20 are passed. Also, for the MCP unit 21, the exit-side electrode 23 is arranged on the side of the electron exit surface 21c. Similar to the incidence-side electrode 22, the exit-side electrode 23 is formed in a circular plate shape and has an opening 23a through which the measurement γ rays and the electrons multiplied and detected by the detector 20 are passed.

Furthermore, with respect to the electron exit surface 21c and exit-side electrode 23 of the MCP unit 21, the detection electrode 24 is further arranged at a predetermined position on the side of the MCX 19. The detection electrode 24 is formed in a circular plate shape and has an opening 24a through which the measurement γ rays are passed. This detection electrode 24 detects the electrons that are incident into the MCP unit 21 from the sample S and are exited from the electron exit surface 21c of the MCP unit 21 after being multiplied, and outputs an obtained current signal as a detection signal.

As the above-described MCP detector 20, for example, an MCP detector with a center hole (F1552-01), manufactured by Hamamatsu Photonics K.K., having a three stage MCP, can be used (see FIG. 5). This MCP detector is configured so that its detection effective area is φ27 mm, thickness is 0.48 mm, and channel diameter is 12 μm and that it has a center hole of φ2.4 mm in the center. An actually prepared spectrometer is configured so that such an MCP detector is mounted on a CF114 conflat flange so that the central axis of its center hole (opening) matches the optical axis of the MCX 19. Furthermore, the distance between the MCP detector 20 and the sample S is set to approximately 10 mm (see FIG. 3). In such a detector, the multiplication factor of electrons is 10⁷ or more, and the dark current is approximately 0.58 cps/cm².

In the embodiment shown in FIG. 2, for the MCP detector 20, a voltage supplying unit 40 is provided. Furthermore, in the voltage supplying unit 40, an electron multiplying power supply 41 and an energy selecting power supply 42 are installed. As the electron multiplying power supply 41, a 3 kV high voltage power supply ORTEC556H can be used, for example. Furthermore, as the energy selecting power supply 42, a high voltage power supply C3360 manufactured by Hamamatsu Photonics K.K. can be used, for example.

The electron multiplying power supply 41 is electron multiplying voltage applying means for applying the electron multiplying voltage between the incidence-side electrode 22 and the exit-side electrode 23 of the detector 20. One end of the electron multiplying power supply 41 is connected to the incidence-side electrode 22 while the other end is connected to the detection electrode 24 via a resistance 31. Moreover, resistance division is provided for the voltage between both ends of the electron multiplying power supply 41 by resistances 36 and 37, and its intermediate point 38 is connected to the exit-side electrode 23. Thereby, between the incidence-side electrode 22 and the exit-side electrode 23 of the MCP detector 20, the electron multiplying voltage for multiplying the electrons with a predetermined multiplication factor is applied, and at the same time, between the exit-side electrode 23 and the detection electrode 24, a detection voltage for detecting the multiplied electrons by the detection electrode 24 is applied. A specific configuration example of the resistance division can be that the resistance 36 is a 2 MΩ resistance and the resistance 37 is a 100 kΩ resistance, for example.

The energy selecting power supply 42 is energy selecting voltage applying means for applying an energy selecting voltage to the electron incident surface 21b of the MCP detector 20 such that its potential is a negative potential with respect to the sample S on the stage 10. By applying such an energy selecting voltage, from among the electrons emitted from the sample S toward the detector 20, the energy of the electrons detected upon reaching the MCP detector 20 is selected.

In the configuration shown in FIG. 2, one end of the energy selecting power supply 42 is connected to the incidence-side electrode 22, and the other end is grounded. Also, the sample S on the stage 10 is set to a predetermined potential, preferably to a ground potential. Thereby, in the present configuration, the incidence-side electrode 22 is arranged for the electron incident surface 21b of the MCP unit 21, and functions as an energy selecting electrode to which the energy selecting voltage is applied.

Furthermore, the detection signal from the detection electrode 24 is output to the exterior via necessary signal processing circuits such as a capacitor 32 and an amplifier circuit 33. As the configuration of the amplifier circuit 33, for example, a preamplifier circuit (for example, ORTEC113) and an amplifier circuit (for example, ORTEC572) can be used in combination. Also, if necessary, a signal processing circuit other than the amplifier circuit may be optionally arranged.

For the XY stage 10, the γ-ray irradiating unit 15, the MCX 19, the MCP detector 20, and the voltage supplying unit 40, etc., a measurement control device 50 is provided. The measurement control device 50 is measurement control means for controlling an irradiation condition of the measurement γ rays by the γ-ray irradiating unit 15, a setting condition of the irradiation position by the XY stage 10 that is irradiation position moving means, and an application condition of the energy selecting voltage by the energy selecting power supply 42.

Specifically, the measurement control device 50 includes a measurement processing unit 51, a radiation source drive control unit 52, a stage control unit 53, and a voltage application control unit 54. The measurement processing unit 51 performs a necessary data process for the measured data including the detection signal acquired by the MCP detector 20, manages and instructs the whole Mossbauer spectrometry operation executed in the spectrometer 1B, and performs other related operations. The detection signal output from the detection electrode 24 of the detector 20 via the amplifier circuit 33, etc., has been input into the measurement processing unit 51.

The radiation source drive control unit 52 controls driving of the γ-ray source 16 in the irradiation axis direction by the radiation source driving device 17 provided in the γ-ray irradiating unit 15. As a result, the Doppler velocity in Mossbauer spectrometry is controlled. The voltage application control unit 54 controls the application of the electron multiplying voltage and the application of the detection voltage by the electron multiplying power supply 41 in the voltage supplying unit 40, and the application of the energy selecting voltage by the energy selecting power supply 42.

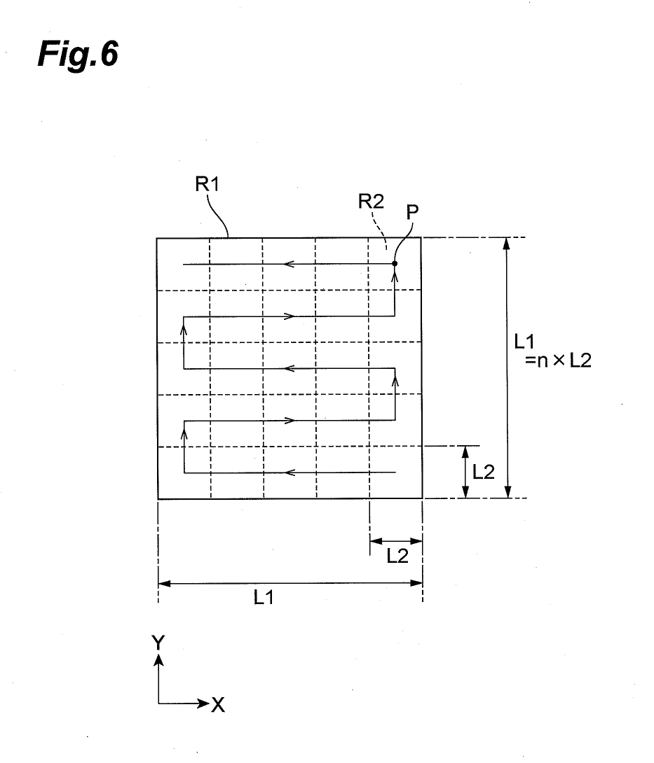

Furthermore, by controlling the operation of the XY gonio stage that is the XY stage 10 functioning as the irradiation position moving means in the present embodiment, the stage control unit 53 two-dimensionally controls the irradiation position of the measurement γ rays with respect to the sample S within the XY plane perpendicular to the irradiation axis Ax. As a specific example of thus controlling the irradiation position, for example, a control method shown schematically in FIG. 6 can be used.

According to method for controlling the irradiation position shown in FIG. 6, an irradiation range R1 in a square shape of L1×L1 set for the sample S is segmented into n×n measurement regions R2 (L1=n×L2), where L2 denotes a segmentation interval. Then, a center position of each of the measurement regions R2 is a measurement position P, and, for example, as shown by solid arrows in FIG. 6, a plurality of measurement positions P are set sequentially as the irradiation positions of γ rays, and in this state, Mossbauer spectrometry is two-dimensionally performed on the whole irradiation range R1.

The irradiation range R1 that is a measurement range for the sample S may be optionally set appropriately according to the size, the type, etc., of the sample S, and for example, L1 can be set to 20 mm. Also, a movement interval L2 of the irradiation positions of γ rays may be optionally set appropriately according to the position resolution, etc., necessary for measuring the sample S, and for example, L2 can be set to 50 μm. Furthermore, the movement interval, etc., of the irradiation positions may be optionally set to different values for the X direction and Y direction.

In the measurement control device 50 shown in FIG. 2, the measurement processing unit 51 specifies the irradiation positions set on the sample S based on the control information in the stage control unit 53, and evaluates measurement results by the detector 20 as a function of the irradiation positions. Thereby, a two-dimensional microscopic image of the target substance in the sample S is acquired. If necessary, the measurement processing unit 51 refers even to information about the Doppler velocity from the radiation source drive control unit 52, information about energy selection of electrons from the voltage application control unit 54, etc., so as to perform a measured data processing.

The measurement control device 50 can be realized by operating software for measurement control (for example, MCS-32 manufactured by ORTEC Corporation) on a personal computer that includes a CPU, a necessary memory, etc., for example. Furthermore, in the configuration shown in FIG. 2, a display device 56 and an input device 57 are connected to this measurement control device 50. The display device 56 is used to display the spectrometry data acquired in the measurement control device 50, or to display the information necessary for executing the spectrometry, and used for other related operations. Also, the input device 57 is used to input, by an operator, the information necessary for executing Mossbauer spectrometry, and used for other related operations.

Effects of the Mossbauer spectrometer according to the above-described embodiment are described.

In the Mossbauer spectrometers 1A, 1B shown in FIG. 1 and FIG. 2, between the γ-ray irradiating unit 15 for supplying the γ rays for spectrometry (for example, γ rays having an energy of 14.4 keV that are emitted from the ⁵⁷Co source) and the sample stage 10 for holding the sample S containing the target substance for spectrometry (for example ⁵⁷Fe), the MCX 19 that is the γ-ray converging unit 18 is arranged, and the sample S is irradiated with the measurement γ rays from the γ-ray source 16 in a converging manner. As a result, the information about the target substance in the sample S can be acquired with high position resolution with respect to the X direction and Y direction.

Furthermore, as the stage 10 for holding the sample S, the XY gonio stage is used, which is made to function as the irradiation position moving means for two-dimensionally moving the irradiation position of the converged measurement γ rays toward the sample S within the XY plane perpendicular to the irradiation axis Ax. Thus, by two-dimensionally scanning on the sample S the irradiation position of the measurement γ rays, it becomes possible to perform two-dimensional measurement of the target substance in the sample S such as measuring a two-dimensional distribution of the target substance in the sample S, for example.

Furthermore, between the γ-ray converging unit 18 and the XY stage 10, the MCP detector 20 having the opening through which the measurement γ rays are passed is placed as the electron detector, and by using this MCP detector 20, the electrons emitted from the sample S are detected. Thus, when the electron detecting means configured to have the opening is used, it becomes possible to preferably make the converged irradiation to the sample S with the measurement γ rays supplied from the γ-ray irradiating unit 15 compatible with the detection, by the MCP detector 20, of the internal conversion electrons from the target substance in which resonance absorption of the γ rays occurs in the sample S.

Furthermore, in such a configuration, the energy selecting power supply 42 is provided which is for applying the energy selecting voltage on the electron incident surface 21b of the MCP detector 20 (see FIG. 4) such that its potential is a negative potential with respect to the sample S on the stage 10. Herein, if the potential of the electron incident surface 21b is 0 (the same potential) with respect to the sample S, the electrons emitted from the sample S are directly incident into and detected by the MCP detector 20.

On the other hand, if the potential of the electron incident surface 21b is negative with respect to the sample S, the electrons emitted from the sample S are decelerated due to the difference in the potential, and only the electrons emitted with energy of a certain level or more are selectively detected upon reaching the MCP detector 20. Regarding the selection of the energy of internal conversion electrons like these, the energy of the internal conversion electrons emitted from the sample S largely depends on the depth (position in the Z direction) from the sample surface at the position where the internal conversion electrons are generated after resonance absorption of γ rays occurs by the target substance in the sample S.

Therefore, when the voltage is thus applied between the electron incident surface 21b of the MCP detector 20 and the sample S and the energy of the electrons detected by the detector 20 is selected, it becomes possible to obtain not only the information about the X direction and Y direction resulting from the movement of the irradiation position, but also the information of the target substance in the sample S about the Z direction that is the direction of depth of the sample S. As described above, according to the Mossbauer spectrometer having the above-described configuration, it becomes possible to acquire the information of a three-dimensional microstructure about the target substance in the sample S. Such three-dimensional measurement of a sample by Mossbauer spectrometry has become possible by the present invention for the first time.

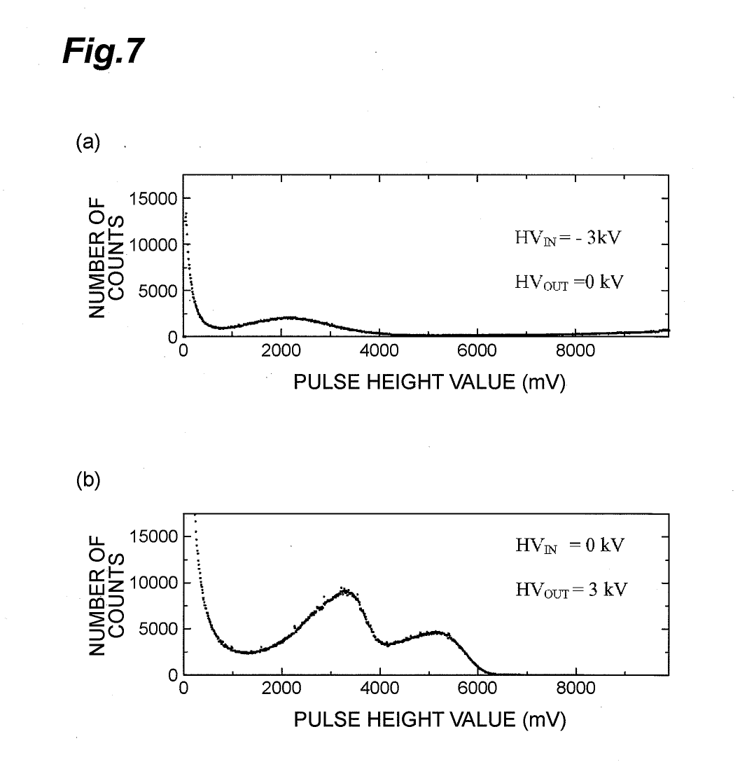

Herein, FIG. 7 shows graphs each showing the energy distribution of electrons detected by the MCP detector 20 in the Mossbauer spectrometer 1B having the configuration shown in FIG. 2, and graph (a) shows the energy distribution of electrons when a voltage of HV_{IN}=−3 kV is applied on the incidence side and that of HV_{OUT}=0 kV is applied on the exit side. Furthermore, graph (b) shows the energy distribution of electrons when a voltage of HV_{IN}=0 kV is applied on the incidence side and that of HV_{OUT}=3 kV is applied on the exit side. In the graphs (a) and (b) in FIG. 7, a horizontal axis shows a pulse height value (mV), which is obtained by the detector 20, corresponding to the energy of the detected electron, while a vertical axis shows a number of counts.

The graph (b) in FIG. 7 shows the energy distribution of electrons when the energy of electrons is not selected, where the electron multiplying voltage is set to 3 kV and the energy selecting voltage is set to 0 kV. In this energy distribution, spectra of the internal conversion electrons of a K shell and an L shell are separated and observed. Furthermore, because the emitted internal conversion electrons lose their energy before reaching the sample surface from the electron emitted position inside the sample S, the energy of the electrons exited to the detector 20 from the sample S will be lower as the emitted position of the electrons is deeper from the surface.

On the other hand, the graph (a) in FIG. 7 shows the energy distribution of electrons when the energy of electrons is selected, where the electron multiplying voltage is set to 3 kV and the energy selecting voltage is set to −3 kV, i.e., a negative voltage. Herein, of the internal conversion electrons emitted from the surface of the sample S, only those with high energy are observed. That is, in this case, the electrons with a low energy that are emitted from a deep portion of the sample S are not able to reach the MCP detector 20 and removed from the measured data, whereas electrons with a high energy that are emitted from near the surface are measured selectively. Thus, by applying a voltage between the electron incident surface 21b of the MCP detector 20 and the sample S, and by selecting the energy of electrons detected by the detector 20, the information about the direction of depth of the sample S can be obtained.

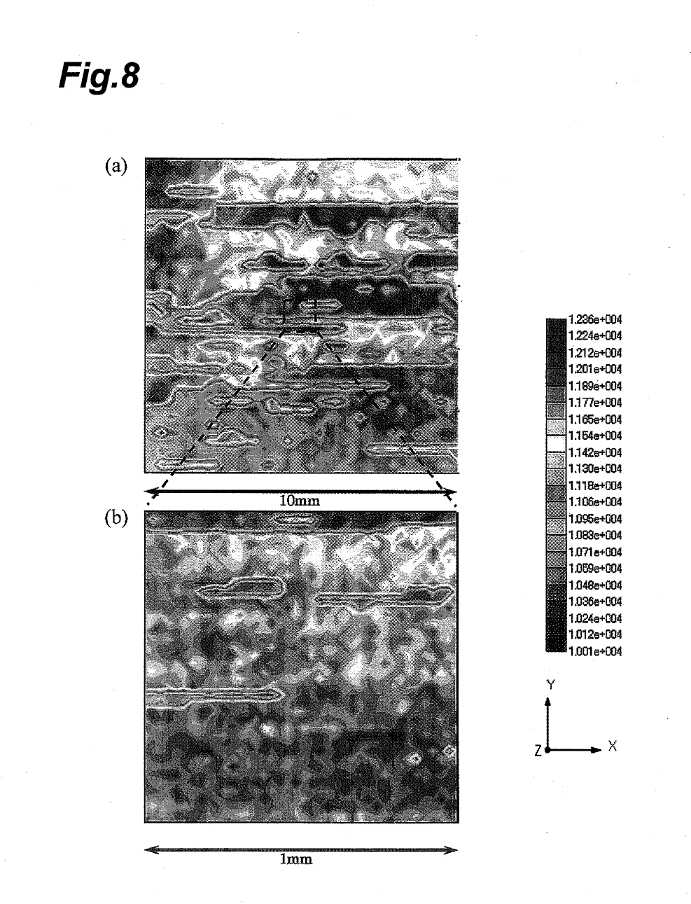

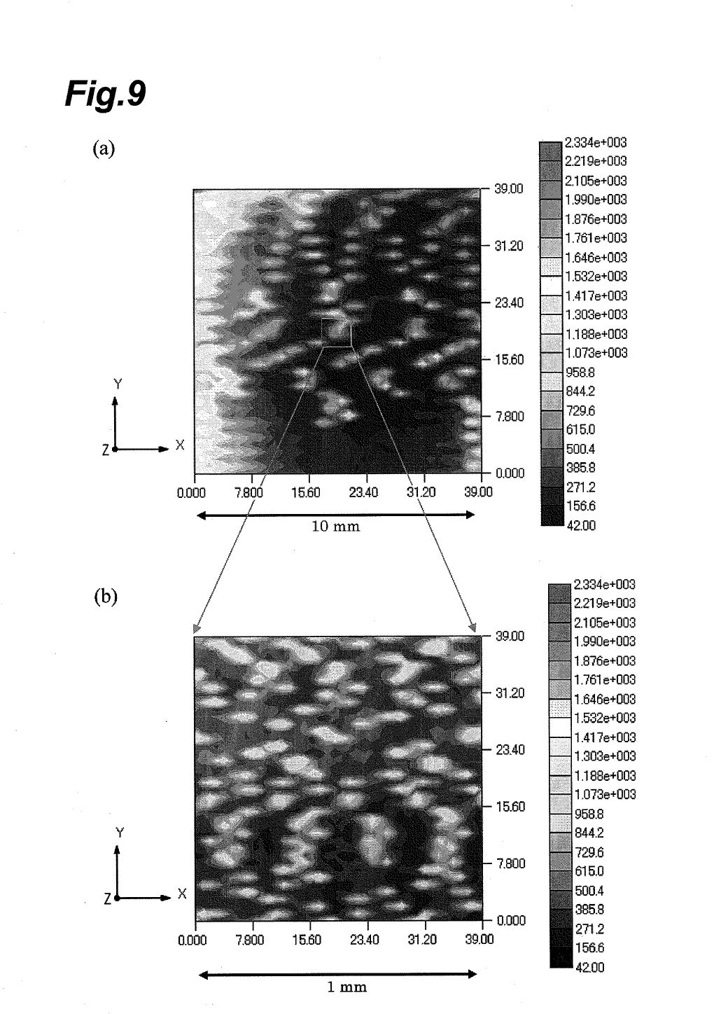

FIG. 8 and FIG. 9 shows diagrams showing examples of a microscopic image of the sample S acquired by using the Mossbauer spectrometer 1B having the configuration shown in FIG. 2. Herein, in each of FIG. 8 and FIG. 9, an image (a) shows a microscopic image obtained by performing spectrometry at 40 steps, where the measurement range is 10×10 mm, and each movement interval of the irradiation position in the X direction and Y direction is 250 μm. Furthermore, an image (b) shows a microscopic image obtained by performing spectrometry at 40 steps, where the measurement range is 1×1 mm, and each movement interval of the irradiation position in the X direction and Y direction is 25 μm.

As the sample S under measurement, used is that in which ⁵⁷Fe, i.e., the target substance under Mossbauer spectrometry, is deposited on the surface of an Si wafer with a thickness of 100 nm, and the resultant is diffused at room temperature toward the inside, thereby forming distribution of iron atoms inside the sample S. Moreover, regarding driving the ⁵⁷Co source 16 in the γ-ray irradiating unit 15, the Doppler velocity is in the range of ±3 mm/s, and the radiation source is vibrated at approximately 12 Hz in the irradiation axis direction, and under these conditions, spectrometry is performed.

Images (a) and (b) in FIG. 8 show microscopic images of two-dimensional distribution of electrons when the energy of electrons is not selected, where the energy selecting voltage is set to 0 kV. On the other hand, images (a) and (b) in FIG. 9 show microscopic images of two-dimensional distribution of electrons when the energy of electrons is selected, where the energy selecting voltage is set to −3 kV.

As can be understood from FIG. 8 and FIG. 9, in the images in FIG. 9 where only the internal conversion electrons from near the surface are measured by applying a negative voltage on the electron incident surface of the detector 20, the two-dimensional distribution of iron atoms, which is clearly different from the images in FIG. 8 in which all electrons are measured, is observed. Particularly, in the two-dimensional distribution observed in FIG. 9, a dot-shaped organization formed by self organization of ⁵⁷Fe is thought to be observed.

As can be understood from the above-described data, according to the Mossbauer spectrometer having the above-described configuration, it is possible to acquire the information about the three-dimensional microstructure of the target substance in the sample S, and thereby, a three-dimensional position sensitive Mossbauer spectrometer (microscopic Mossbauer spectrometer) can be realized. The spatial resolution in the XY directions achieved until now is around 20 μm and the resolution in the direction of depth is around several tens of nm. Furthermore, although the γ-ray source such as the ⁵⁷Co source is required in the above-described spectrometer, if registered as a radiation source built inside the spectrometer, its use may be possible even if there is no radiation controlled area. This is effective from the viewpoint of application of Mossbauer spectroscopy.

Herein, as the energy selecting power supply 42, for example, a power supply configured to enable switching between an applied voltage of 0 when the energy of electrons is not selected and a negative applied voltage when the energy of electrons is selected can be used. Generally, it is preferable that the energy selecting voltage applying means be configured at least to enable switching between a first voltage where the potential of the electron incident surface of the electron detector is either 0 or a negative potential with respect to the sample and a second voltage that is different from the first voltage where the potential of the electron incident surface is a negative potential with respect to the sample. Furthermore, a variable voltage power supply configured to enable variable setting of the applied voltage within a predetermined voltage range may be optionally used to configure so that selection conditions of the energy of electrons are controlled by a set voltage value.

As for a specific configuration of the irradiation position moving means for two-dimensionally moving the irradiation position of the γ rays with respect to the sample S, the above-described embodiment uses, as the sample stage, the XY stage 10 that is configured to enable two-dimensional movement of the sample S within the plane perpendicular to the irradiation axis and that is a movable stage functioning as the irradiation position moving means. Thereby, it becomes possible to preferably control the irradiation positions of γ rays with respect to the sample S.

Furthermore, the spectrometer 1B shown in FIG. 2 is configured so that the measurement control device 50 for controlling the operation of each unit of the spectrometer 1B is provided. This enables preferable control of the spectrometric operation in the Mossbauer spectrometer having the above-described configuration. However, such measurement control may be optionally configured so that some or all operations are manually performed by an operator. Examples of such a configuration include that in which an operator manually operates the power supplies 41 and 42 to set the electron multiplying voltage and the energy selecting voltage, and then executes the spectrometry for the set voltage conditions.

In the spectrometer of the above-described embodiment, Mossbauer spectrometry is performed by detecting the internal conversion electrons emitted from the target substance in the sample S in which the measurement γ rays are absorbed in resonance by the Mossbauer effect. Moreover, it may be optionally configured that as the γ ray detector 29 is schematically shown in FIG. 5, for example, a γ ray detector is also installed rearward of the sample S such that the detection of internal conversion electrons and the detection of transmitted γ rays are performed together so as to perform Mossbauer spectrometry.

Also, because the spectrometer can incorporate a general scanning electron microscope, it will become possible in the future to examine the micro-organization of materials in further detail by using the spectrometer together with SEM microscopy.

As for a specific measurement according to the Mossbauer spectrometer of the above-described embodiment, as described above, the γ-ray irradiating unit 15 can be configured by the ⁵⁷Co source 16 that is a γ-ray source and the radiation source driving device 17 for driving the ⁵⁷Co source in the direction of the irradiation axis, and at the same time, the target substance included in the sample S can be configured to be the ⁵⁷Fe.

In such a configuration, unlike a normal fluorescent X-ray mapping, etc., the Mossbauer effect can be used to selectively measure only the ⁵⁷Fe atoms in the sample S, thereby enabling the acquisition of the information about the distribution, a state, etc., of the iron atoms in the sample. Also, in such Mossbauer spectrometry, it is possible to perform image measurements of extremely minute iron atoms to the extent of ppm. Furthermore, a chemical state, a lattice vibration state, etc., of the Fe atoms can also be distinguished by performing normal Mossbauer spectral measurement, and mapping measurement can be performed for each spectral component.

Thus, by using the spectrometer having the above-described configuration, for example, it becomes possible to evaluate in detail the relationship between the extreme micro-organization in materials such as Si wafers; and the distribution, chemical state, and other related states of the Fe atoms. Materials including iron atoms are very large in number, including steel materials and mineral substances, and even up to biomaterials. Therefore, the present spectrometer capable of direct observation of three-dimensional mapping images in a nanometer scale by responding to different states of the iron atoms in the materials as described above is expected to be used as a device with significantly wide applications in the engineering, medical, archaeological, geological, and other related fields. Also, the target substances under such Mossbauer spectrometry may optionally include not only the above-described ⁵⁷Fe but also other substances which are generally under Mossbauer spectrometry, depending on the purpose of spectroscopy.

In the above-described configuration example, as the converging means for converging the measurement γ rays into the sample S, the multi capillary lens (MCX) 19 formed by bundling together a plurality of hollow tubes so as to converge the measurement γ rays into the sample S is used. By using the MCX for converging the γ rays, the γ rays, which are supplied from the γ-ray source, used for Mossbauer spectrometry can be preferably converged into the irradiation position on the sample, thereby realizing Mossbauer spectrometry at high spatial resolution such as at a spatial resolution of approximately 20 μm, for example.

For such converging means for the measurement γ rays, a configuration other than the above-described MCX may also be optionally used. An example of such a configuration may include that which is used by combining a KB mirror (Kirkpatrick-Baez Mirrors, see Document “K. Yamauchi et al., “Hard X-ray Diffraction-Limited Nanofocusing with Kirkpatrick-Baez Mirrors,” Japanese Journal of Applied Physics Part 2, 44 (18), L539-L542 (2005)”) with the MCX. With such a configuration, it is possible to expect to achieve high spatial resolution of around several tens of nm.

In the above-described configuration example, as the electron detecting means for detecting the internal conversion electrons emitted from the target substance in the sample S, the MCP detector 20 is used. By using such an electron detector adopting an MCP having an electron multiplying function, the electrons emitted from the sample S can be reliably detected. Also, by introducing a configuration such that an energy selecting voltage is applied to an electrode arranged on the side of the electron incident surface of the MCP detector 20, the detection of electrons from the sample S and the selection of energy of electrons can be preferably realized.

For the MCP detector 20, it is generally preferable to use a configuration having an MCP unit which has an electron multiplying function, which is configured by an MCP of a single stage or a plurality of stages, which includes the opening through which the measurement γ rays are passed, and which is configured such that its one surface is an electron incident surface and the other surface is an electron exit surface; a detection electrode which includes an opening through which the measurement γ rays are passed, and which detects the electrons exited from the electron exit surface of the MCP unit and outputs the obtained electric current signal as the detection signal; and an energy selecting electrode which is arranged with respect to the electron incident surface of the MCP unit and on which the energy selecting voltage is applied.

The energy selecting electrode in this case adopts, in the above-described configuration, a configuration such that the incidence-side electrode 22 arranged for applying the electron multiplying voltage is used as the energy selecting electrode. Thereby, it becomes possible to realize the application of the energy selecting voltage to the electron incident surface of the MCP unit with a simple configuration. However, the energy selecting electrode may be optionally configured such that the energy selecting electrode is arranged separately of the incidence-side electrode used for applying the electron multiplying voltage.

Subsequently, the acquisition of the information about the direction of depth of the sample S by selecting the energy of the internal conversion electrons through the application of the energy selecting voltage is further described.

According to the above-described Mossbauer spectrometer, in the configuration shown in FIG. 1, by applying a negative voltage (for example, a voltage of 0 to −6 kV with respect to the sample S) on the side of the electron incident surface of the MCP detector 20, it becomes possible to select the energy component of the internal conversion electrons detected by the detector 20, as described above. Moreover, for example, in the energy spectrum of the internal conversion electrons shown in FIG. 7, if the measurement range is limited to a specific energy range, the information on the depth direction in the sample S can be acquired.

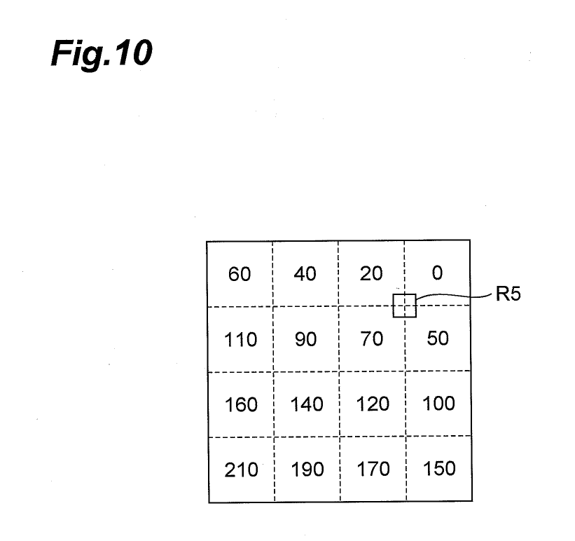

The correlation between the spectrometric conditions (for example, the voltage conditions set for energy selection) and the position in the depth direction in the sample S in this case can be studied in detail by performing measurements using, for example, a sample for depth calibration as shown in FIG. 10. Then, by referring to the calibration information thus obtained, the information on the direction of depth of the sample S can be preferably acquired.

Specifically, as the sample for calibration that is shown in FIG. 10, it is possible to use a sample in which ⁵⁷Fe of a thickness of 50 nm is deposited on the surface of an Si wafer, and following this, a special mask is used to deposit Ag at a thickness of 0 nm to 210 nm. In FIG. 10, the thickness of Ag in each of 16 (4×4) regions two-dimensionally segmented is expressed in units of nm.

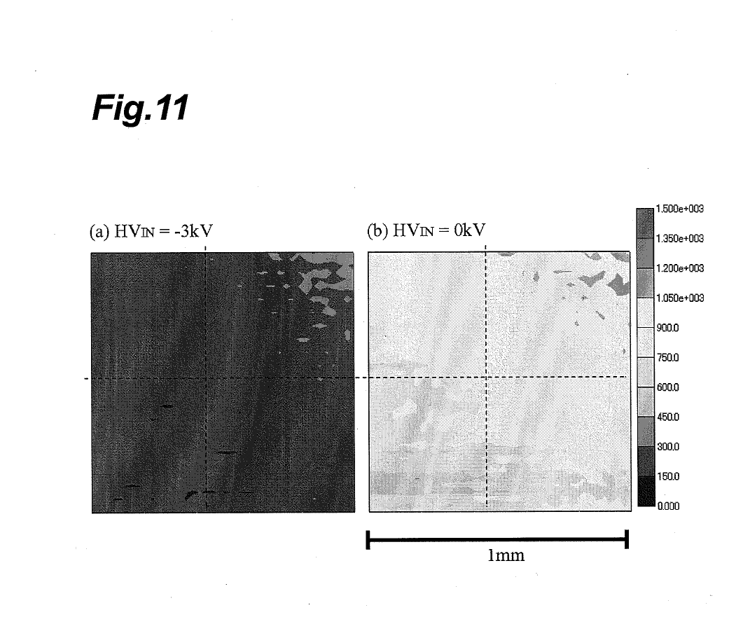

On the sample for calibration, spectrometry was performed at 40 steps, where a 1×1 mm range R5 including four regions with an Ag thickness of 0, 20, 50, and 70 nm as shown in FIG. 10 was used as the measurement range, and each movement interval of the irradiation position in the X direction and Y direction was 25 μm, and microscopic images obtained during the spectrometry are shown in FIG. 11. An image (a) in FIG. 11 shows a microscopic image of two-dimensional distribution of electrons when the energy of electrons is selected where the energy selecting voltage is set to −3 kV. An image (b) in FIG. 11 shows a microscopic image of two-dimensional distribution of electrons when the energy of electrons is not selected, where the energy selecting voltage is set to 0 kV.

In both of these images (a) and (b) in FIG. 11, a top right region in which Ag is not deposited at all shows the highest count values. Particularly, in the image (a) where the energy of internal conversion electrons is selected, the electrons are measured substantially only in the top right region, and the internal conversion electrons from the other Ag deposited portions are not measured. This indicates that due to the application of the energy selecting voltage, it becomes possible to acquire the information about distribution of ⁵⁷Fe atoms present on different depths from the surface of the sample in the sample S.

Subsequently, a configuration in which the Mossbauer spectral measurement based on the Doppler velocity is performed and the mapping measurement for each spectral component is performed will be described.

According to the above-described Mossbauer spectrometer, in the configuration shown in FIG. 1, by driving the γ-ray source 16 in the direction of the irradiation axis Ax using the radiation source driving device 17, it becomes possible to acquire the Mossbauer spectrum for the Doppler velocity. Then, by using the information about such a Mossbauer spectrum in combination with the above-described three-dimensional mapping information, a larger amount of information about the target substance in the sample S can be obtained.

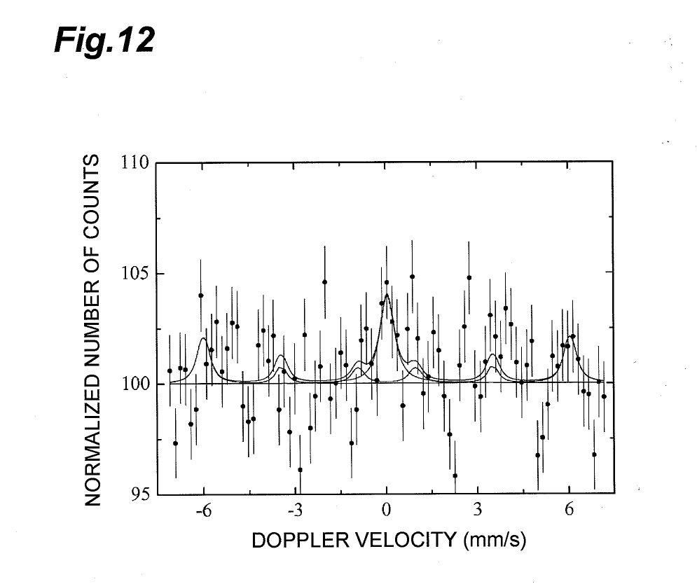

FIG. 12 is a graph showing one example of the Mossbauer spectrum of the sample S acquired by using the Mossbauer spectrometer 1B having the configuration shown in FIG. 2. In this graph, a horizontal axis shows the Doppler velocity (mm/s) and a vertical axis shows a normalized number of counts. Similar to the sample S under measurement in FIG. 8 and FIG. 9, that in which the ⁵⁷Fe with a thickness of 100 nm is deposited on the surface of an Si wafer and the resultant is diffused toward the inside at room temperature, thereby forming distribution of iron atoms inside the sample S, is used.

According to the graph of FIG. 12, it is understood that due to interdiffusion at a boundary face (at a depth of 100 nm from the sample surface) between Fe and Si after deposition, iron silicide principally including Fe₃Si, and iron component dissolved inside silicon are present in the sample S. It is noted that because the irradiation range of the measurement γ rays is very small, i.e., approximately φ150 μm, the statistics of the spectrum appear to be somewhat less satisfactory, but such spectral statistics can be improved through further measurements.

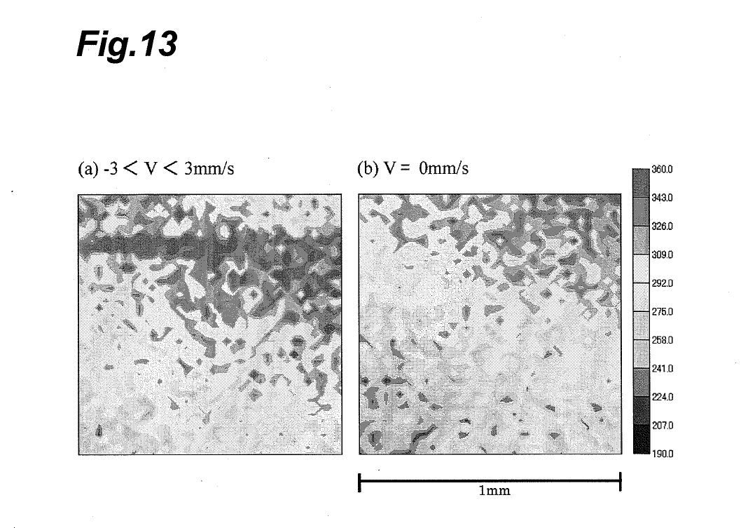

FIG. 13 shows diagrams showing examples of microscopic images of the sample S acquired by selecting the spectral components in such a Mossbauer spectrum. Herein, in FIG. 13, an image (a) shows a microscopic image obtained by measuring the spectral components where the Doppler velocity V is −3<V<3 mm/s. Furthermore, an image (b) shows a microscopic image obtained by measuring only the spectral components where the Doppler velocity V is V=0 mm/s.

Of these images (a) and (b) in FIG. 13, the right-side image (b) shows the distribution of the iron component dissolved in the silicon formed under the boundary face between Fe and Si that is formed at a depth of 100 nm from the surface. Moreover, the left-side image (a) shows the distribution obtained by combining the iron silicide and the iron component dissolved in the silicon. Thus, in the Mossbauer spectrum, by selecting the Doppler velocity according to the spectral components, the microscopic images of the sample S corresponding to various components can be acquired.

The Mossbauer spectrometer according to the present invention is not restricted to the above-described embodiment and configuration examples, and various modifications are possible. For example, in the above-described embodiment, as the electron detecting means for detecting the internal conversion electrons emitted from the target substance in the sample S, the MCP detector is used as an example, however, as such an electron detector, detectors other than the MCP detector may optionally be used.

Herein, the Mossbauer spectrometer according to the above-described embodiment uses a configuration including: (1) a sample stage for holding a sample containing a target substance under Mossbauer spectrometry; (2) γ-ray irradiating means, having a γ-ray source for supplying measurement γ rays, that is, γ rays having a predetermined energy and used for Mossbauer spectrometry, for irradiating the sample with the measurement γ rays along a predetermined irradiation axis; (3) converging means, placed between the γ-ray irradiating means and the sample stage, for irradiating the sample with the measurement γ rays in a converging manner; (4) electron detecting means, placed between the converging means and the sample stage, having an opening through which the measurement γ rays from the converging means are passed, and configured so that a surface on a side of the sample stage is used as an electron incident surface, for detecting internal conversion electrons emitted from the target substance in the sample in which the measurement γ rays are absorbed in resonance by the Mossbauer effect; (5) irradiation position moving means for two-dimensionally moving an irradiation position of the measurement γ rays with respect to the sample within a plane perpendicular to the irradiation axis; and (6) energy selecting voltage applying means for selecting energy of the electrons detected by the electron detecting means, out of the electrons from the sample, by applying an energy selecting voltage to the electron incident surface of the electron detecting means so that a potential of the electron incident surface is a negative potential with respect to the sample on the sample stage.

As for a specific measurement according to the Mossbauer spectrometer having the above-described configuration, the γ-ray irradiating unit is configured by the ⁵⁷Co source that is the γ-ray source and includes the radiation source driving means for driving the ⁵⁷Co source in the direction of the irradiation axis, and at the same time, the target substance included in the sample S is configured to be the ⁵⁷Fe. In this case, it is possible to acquire the information about the distribution, a state, etc., of the iron atoms in the sample. Also, besides the ⁵⁷Fe, other substances generally under Mossbauer spectroscopy may be optionally used as the target substance.

As a specific example of the converging means for converging the measurement γ rays into the sample, it is preferable to use the multi capillary lens formed by bundling together a plurality of hollow tubes so as to converge the measurement γ rays onto the sample. By doing this, the γ rays to be used for Mossbauer spectrometry that are supplied from the γ-ray source can be preferably converged into the irradiation position on the sample.

As for a specific configuration of the irradiation position moving means for two-dimensionally moving the irradiation position of the γ rays with respect to the sample, it is preferable to use, as the sample stage, a movable stage that is configured to enable two-dimensional movement of the sample within the plane perpendicular to the irradiation axis and that functions as the irradiation position moving means.

Moreover, as a specific example of the electron detecting means for detecting internal conversion electrons emitted from the target substance in the sample, the electron detecting means is preferably an MCP detector including: (a) an MCP unit, formed by a micro channel plate of a single stage or a plurality of stages, having an opening through which the measurement γ rays are passed, configured so that its one surface is the electron incident surface and the other surface is an electron exit surface, and having an electron multiplying function of multiplying the electrons incident from the sample as a result of an electron multiplying voltage being applied between the electron incident surface and the electron exit surface; (b) a detection electrode, having an opening through which the measurement γ rays are passed, for detecting the electrons exited from the electron exit surface of the MCP unit and outputting an obtained current signal as a detection signal; and (c) an energy selecting electrode which is arranged for the electron incident surface of the MCP unit and to which the energy selecting voltage is applied.

In this way, by using the MCP detector using a micro channel plate (MCP) having an electron multiplying function as an electron detector, the electrons emitted from the sample can be reliably detected. Also, by introducing a configuration such that an energy selecting voltage is applied to an electrode arranged on the side of the electron incident surface of the MCP detector, the detection of electrons from the sample and the selection of energy of electrons can be preferably realized.

Furthermore, it is preferable that the spectrometer include measurement control means for controlling an irradiation condition of the measurement γ rays by the γ-ray irradiating means, a setting condition of the irradiation position by the irradiation position moving means, and an application condition of the energy selecting voltage by the energy selecting voltage applying means. This enables preferable control of the spectrometric operation in the Mossbauer spectrometer having the above-described configuration.

### INDUSTRIAL APPLICABILITY

The present invention can be utilized as a Mossbauer spectrometer capable of acquiring information about the microstructure of a target substance in a sample.

1. A Mossbauer spectrometer, comprising:
a sample stage for holding a sample containing a target substance under Mossbauer spectrometry;
γ-ray irradiating means, having a γ-ray source for supplying measurement γ rays having a predetermined energy and used for spectrometry, for irradiating the sample with the measurement γ rays along a predetermined irradiation axis;
converging means, placed between the γ-ray irradiating means and the sample stage, for irradiating the sample with the measurement γ rays in a converging manner;
electron detecting means, placed between the converging means and the sample stage, having an opening through which the measurement γ rays from the converging means are passed, and configured so that a surface on a side of the sample stage is used as an electron incident surface, for detecting internal conversion electrons emitted from the target substance in the sample in which the measurement γ rays are absorbed in resonance by the Mossbauer effect;
irradiation position moving means for two-dimensionally moving an irradiation position of the measurement γ rays with respect to the sample within a plane perpendicular to the irradiation axis; and
energy selecting voltage applying means for selecting energy of the electrons detected by the electron detecting means, out of the electrons from the sample, by applying an energy selecting voltage to the electron incident surface of the electron detecting means so that a potential of the electron incident surface is a negative potential with respect to the sample on the sample stage.

2. The Mossbauer spectrometer according to claim 1, wherein
the γ-ray irradiating means includes a ⁵⁷Co source being the γ-ray source and radiation source driving means for driving the ⁵⁷Co source in a direction of the irradiation axis, and
the target substance included in the sample is ⁵⁷Fe.

3. The Mossbauer spectrometer according to claim 1, wherein
the converging means is a multi capillary lens formed by bundling together a plurality of hollow tubes so as to converge the measurement γ rays onto the sample.

4. The Mossbauer spectrometer according to claim 1, wherein
the electron detecting means is an MCP detector comprising:
an MCP unit, formed by a micro channel plate of a single stage or a plurality of stages, having an opening through which the measurement γ rays are passed, configured so that its one surface is the electron incident surface and the other surface is an electron exit surface, and having an electron multiplying function of multiplying the electrons incident from the sample as a result of an electron multiplying voltage being applied between the electron incident surface and the electron exit surface;
a detection electrode, having an opening through which the measurement γ rays are passed, for detecting the electrons exited from the electron exit surface of the MCP unit and outputting an obtained current signal as a detection signal; and
an energy selecting electrode which is arranged with respect to the electron incident surface of the MCP unit and to which the energy selecting voltage is applied.

5. The Mossbauer spectrometer according to claim 1, wherein
the sample stage is formed by a movable stage that is configured to enable two-dimensional movement of the sample within the plane perpendicular to the irradiation axis and that functions as the irradiation position moving means.

6. The Mossbauer spectrometer according to claim 1, further comprising:
measurement control means for controlling an irradiation condition of the measurement γ rays by the γ-ray irradiating means, a setting condition of the irradiation position by the irradiation position moving means, and an application condition of the energy selecting voltage by the energy selecting voltage applying means.
